(19) United States
(12) Patent Application Publication
(10) Pub. No.: US 2014/0279657 A1
(43) Pub. Date: Sep. 18, 2014

(54) SYSTEM AND METHOD FOR RATE-BASED SELECTION OF DELIVERY SERVICE

(71) Applicant: Michael Stowe, Chicago, IL (US)

(72) Inventor: Michael Stowe, Chicago, IL (US)

(73) Assignee: KEWILL INC., CHELMSFORD, MA (US)

(21) Appl. No.: 14/151,155

(22) Filed: Jan. 9, 2014

Related U.S. Application Data
(60) Provisional application No. 61/789,515, filed on Mar. 15, 2013.

(51) Int. Cl. G06Q 10/08

(52) U.S. Cl. CPC G06Q 10/08345
USPC 705/335

(57) ABSTRACT

A shipper selection system for selecting a shipping service provider is provided. The shipping selection system includes a parameters determining module for determining parameters of a package to be shipped, a retrieval module for retrieving shipping cost rules for one or more shipping service providers, a contract module for retrieving contract rules for the one or more shipping service providers, and a calculating module for calculating one or more shipping costs based upon the determined parameters, retrieved shipping cost rules, and retrieved contract rules. The shipper selection system further includes a selection module for selecting a shipping service provider based upon the calculated one or more shipping costs. The shipper selection system further includes an update module configured to enable the one or more shipping service provider to update a geographic range or shipping cost rules for his shipping services.

### CROSS-REFERENCE TO RELATED APPLICATIONS

This application claims the benefit of U.S. Provisional Application Ser. No. 61/789,515, filed on Mar. 15, 2013, and entitled SYSTEM AND METHOD FOR RATE-BASED SELECTION OF DELIVERY SERVICE, which is incorporated herein by reference in its entirety.

### BACKGROUND

1. Field of the Invention

Embodiments of the present invention generally relate to shipping services. More particularly, embodiments of the present invention provide a system and a method for selecting a shipping service provider among multiple shipping service provider based upon specific factors of the shipment.

2. Description of Related Art

Individuals and businesses in the United States and around the world often need to ship a shipment from an origin to a destination. A plurality of shipping service providers offers this service of delivering or shipping the shipment from the origin to the destination. Each of the plurality of shipping service providers offers its own pricing policies and distribution channels to ship the shipment. Certain shipping service providers have a relatively straightforward zone system, where they divide the country into a certain number of zones, and determine those particular zones based on zip code. Exceptions may be added to the zones by the shipping service providers. Additional billing layers, based on zip codes, may be used for rural areas. Additional billing layers or service availability, based on address, may be used for locations with difficult pickup or delivery, access restrictions, mode of access, tolls (e.g., by ferry), etc. Billing charges may also be dependent upon characteristics of the individual package, e.g., dimensions (length, width, height), circumference in one or more dimensions, weight, type of packaging, type of contents (e.g., printed material; hazardous material), special handling requirements (e.g., fragile), insurance, speed of delivery (e.g., overnight or bulk mail), and so forth. Package-related expenses may vary with the pick-up and/or delivery locations.

Such billing layers, zones, etc., used by each shipping service provider needs to be known to a shipping charge calculator in advance in order to provide accurate shipping cost estimates, delivery times, and availability. Further, each of the shipping service providers may require updating their shipping rate rules. However, such billing structures are very complex and difficult to update.

Conventional methods and systems for tracking changes in shipping rate rules use structures expressed using database scripting language. Every time a shipping rate changes or an exception or special circumstance is added or deleted, the database structures expressed in this scripting language code needs to be modified. Further, it is very difficult to update such billing structures or verify such billing structures for accuracy.

Therefore, there is a need for an improved system and method that is capable of tracking and making changes to billing structures used by shipping service providers. Further, there is a need for an improved system and method that can provide more accurate shipping cost estimates to a shipper. Further, there is a need for an improved system and method that can select a shipping service provider among multiple shipping service providers based upon user requirement.

### SUMMARY

Embodiments in accordance with the present invention provide a shipper selection system for selecting a shipping service provider. The shipper selection system includes a parameter determining module for determining parameters of a package to be shipped, a retrieval module for retrieving shipping cost rules for one or more shipping service providers, and a contract module for retrieving contract rules for the one or more shipping service providers. The shipper selection system further includes a calculating module for calculating one or more shipping costs based upon the determined parameters, retrieved shipping cost rules, and retrieved contract rules. The shipper selection system further includes a selection module for selecting a shipping service provider based upon the calculated one or more shipping costs. The shipper selection system further includes a profile module configured to enable the one or more shipping service providers to register a geographic range and shipping cost rules for his shipping services. The shipper selection system further includes an update module configured to enable the one or more shipping service provider to update a geographic range or shipping cost rules for his shipping services.

The bundle of content of arbitrary shipper rules contains declarative as well as sequential elements, which distinguishes it from other systems based on code or scripting for sequential logic and a database or files for declarative data such as rate tables.

An embodiment of the present invention comprises a system, wherein the expression of carrier rules and shipper rules are segregated and layered, facilitating the mobility of carrier content without exposing any proprietary customer data or relationships.

Embodiments in accordance with the present invention further provide a computer-implemented method for selecting a shipping service provider among multiple shipping service provider based upon user requirement. The computer-implemented method includes determining parameters of a package to be shipped, retrieving shipping cost rules for one or more shipping service providers, retrieving contract rules for the one or more shipping service providers, and calculating one or more shipping costs based upon the determined parameters, retrieved shipping cost rules, and retrieved contract rules. The computer implemented method further includes selecting a shipping service provider based upon the calculated one or more shipping costs. The computer implemented method further includes enabling the one or more shipping service provider to update a geographic range or shipping cost rules for his shipping services.

Further, the present invention can provide a number of advantages depending on its particular configuration. First, embodiments of the present invention provide a large volume shipper (or any shipper) ability to select a shipping service provider (from a plurality of shipping service providers) offering minimum shipping cost for a class of package service (e.g., over-night or two day). Further, embodiments of the present invention provide the large volume shipper (or any shipper) a greater visibility into the effect of shipping cost from various shipping options or package characteristics. Hence, the large volume shipper (or any shipper) can better determine shipping cost to charge customers, and offer to the customers a range of choices, or even decide whether to absorb shipping costs. Further, embodiments of the present invention do not expose a shipping cost logic used by shipping service providers.

Further, embodiments of the present invention enables shipping service provider to easily express (and update) idiosyncrasies in shipping rate rules. The idiosyncrasies can be easily updated by the shipping service providers by updated parameters when invoked, rather than updated scripting language (as conventionally done). Further, embodiment of the present invention enables separation (or bifurcation) of a shipping service provider specific idiosyncrasies (e.g., specific contract) from his general shipping cost rules.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 shows an illustrative embodiment of the present invention depicting an enterprise network and a communication network, in accordance with an embodiment of the present invention;

FIG. 2 is a block diagram of modules, in accordance with an embodiment of the present invention;

FIG. 3 is flowchart of a method for enabling a shipping service provider to provide details of his shipping services, in accordance with an embodiment of the present invention; and

FIG. 4 is a flowchart of a method for selecting a shipping service provider among a plurality of shipping service providers, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The present invention will be illustrated below in conjunction with an exemplary communication system, e.g., enterprise network. Although well suited for use with any enterprise network, the present invention is not limited to any particular type of communication network or configuration of system elements. Those skilled in the art will recognize the disclosed techniques may be used in any communication network in which it is desirable to provide improved shipping options to a shipper.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

FIG. 1 depicts a network environment 100 according to an embodiment of the present disclosure. The network environment 100 may include a shipper selection system 102. The shipper selection system 102 includes an enterprise network 104. The shipper selection system 102 is in communication, via a (typically unsecured or public network) communication network 108, with one or more external communication devices 112. The external communication devices 112 are generally referred to as “external” because they are either not under the direct control of the enterprise administering the enterprise network 104 or have a decreased level of trust with the enterprise network 104 as compared with communication devices 136 that are within the enterprise network 104. Exemplary types of external communication devices 112 include, without limitation, cellular phones, laptops, Personal Computers (PCs), Personal Digital Assistants (PDAs), digital phones, analog phones, and the like.

The communication network 108 may be packet-switched and/or circuit-switched. An exemplary communication network 108 includes, without limitation, a Wide Area Network (WAN), such as the Internet, a Public Switched Telephone Network (PSTN), a Plain Old Telephone Service (POTS) network, a cellular communications network, or combinations thereof. In one configuration, the communication network 108 is a public network supporting the TCP/IP suite of protocols.

The enterprise network 104 may include a boundary device 116 including a server table 120, a communication server 124 including a call feature sequencer 128 and a user table 132, one or more internal communication devices 136, one or more application servers 144 that may be capable of providing one application 148 or a set of different applications 152, a number of other servers 156, and an enterprise database 160, all of which are interconnected by a (trusted or secure or private) Local Area Network (LAN) 164. Some or all of the functions depicted in FIG. 1 may be co-hosted and/or co-resident on a single server. The depiction of components in FIG. 1 is generally intended to be a logical depiction of the components of the system 100.

The LAN 164 can be secured from intrusion by untrusted parties by a gateway and/or firewall located between the LAN 164 and communication network 108. In some embodiments the boundary device 116 may include the functionality of the gateway and/or firewall. In some embodiments, a separate gateway or firewall may be provided between the boundary device 116 and the communication network 108.

The communications server 124 can include a Private Branch eXchange (PBX), an enterprise switch, an enterprise server, combinations thereof, or other type of telecommunications system switch or server.

Although only a single communications server 124 is depicted in FIG. 1, two or more communications servers 124 may be provided in a single enterprise network 104 or across multiple separate LANs 164 owned and operated by a single enterprise, but separated by a communication network 108. In configurations where an enterprise or an enterprise network 104 includes two or more communications servers 124, each server 124 may comprise similar functionality, but may be provisioned for providing its features to only a subset of all enterprise users. In particular, a first communications server 124 may be authoritative for and services a first subset of enterprise users whereas a second communications server 124 may be authoritative for and services a second subset of enterprise users, where the first and second subsets of users generally do not share a common user. This is one reason why the network boundary device 116 may be provided with a server table 120.

Additionally, multiple servers 124 can support a common user community. For example, in geo-redundant configurations and other applications where users aren't necessarily bound to a single application server, there may be a cluster of equivalent servers where a user can be serviced by any server in the cluster.

Although only two application servers 144 are depicted, one skilled in the art will appreciate the one, two, three, or more applications servers 144 can be provided and each server may be configured to provide one or more applications. The applications provided by a particular application server 144 may vary depending upon the capabilities of the server 144 and in the event that a particular application server 144 comprises a set of applications 152, one, some, or all of the applications in that set of applications 152 may be included in a particular application sequence.

Embodiments in accordance with the present invention may use enterprise network 104 to determine shipping rates for multiple shipping service providers. A user (e.g., a large volume shipper or any shipper) desiring to determine shipping costs may use external communication device 112, through communication network 108, to access enterprise network 104. Shipping cost rule information may be stored in enterprise database 160. Contract rule information may be stored in contract database 168. One or more of servers 144 may interpret requests originating from external communication device 112, calculate the appropriate shipping cost(s), and return results to external communication device 112. Communication within enterprise network 104 may be managed at least in part by server 124. Administrative and performance monitoring tasks may be handled by one or more of servers 144 and/or 156, with supporting data stored in database 162. Communication devices 136 may be used to provide local control and monitoring of enterprise network 104.

Although the preferred embodiment is discussed with reference to client-server architecture, it is to be understood the principles of the present invention apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks. The term “server” as used herein should be understood to include a PBX, an enterprise switch, an enterprise server, or other type of telecommunications system switch or server, as well as other types of processor-based communication control devices such as media servers, computers, adjuncts, etc.

It should be noted the present invention does not require any particular type of information transport medium between server and first and second communication devices, i.e., the present invention may be implemented with any desired type of transport medium as well as combinations of different types of transport channels.

It should be emphasized the configuration of the enterprise network 104, user communication devices 112, and other elements as shown in FIG. 1 is for purposes of illustration only and should not be construed as limiting the present invention to any particular arrangement of elements.

The enterprise network 104, as shown in FIG. 1, further includes a memory 172. The memory 172 includes various modules 176. The memory 172 may be coupled with a processor. The modules 176 include as shown in FIG. 2, but not restricted to, profile module 202, update module 204, parameter determining module 206, retrieval module 208, contract module 210, calculating module 212, and selection module 214.

The profile module 202 may enable a shipping service provider to register on the shipper selection system 102. The shipping service provider may list shipper details of his shipping services. The shipper details may include, but not be limited to geographic areas (or zones) where the shipping service provider provides his services. In an embodiment, the geographic details may be automatically retrieved by the profile module 202 from a shipping service provider proprietary system.

In another embodiment, the geographic details may be provided by the shipping service provider. The profile module 202 may provide various geographic codes for various geographic origin, which may be selected by the shipping service provider to indicate his geographic range of operations for picking up (i.e., origin of package) and delivering the shipments (i.e., destination of the package). In an embodiment, the geographic code may provide information about country, state and city. The profile module 202 may also enable the shipping service provider to create zones within a particular country or outside the country. The shipper details may further include routing methods for each pair of origin and destination. The shipper details may further include expertise of the shipping service provider related to specific type of packages or specific places for speedy operation.

The profile module 202 may further enable the shipping service provider to provide shipping cost rules for his shipping services. In an embodiment, the shipping cost rules may be automatically retrieved by the profile module 202 from a shipping service provider proprietary system. In another embodiment, the shipping cost rules may be provided by the shipping service provider. The shipping cost rules may specify base charge of the shipping service provider. Further, the shipping cost rules may further specify service charge, surcharge etc. The shipping cost rules may further include specific charges of the shipping service provider that may be applicable for given types of packages or given origin of shipment, or given destination of the shipment. The shipping cost rules may further include additional charges based on distance between an origin of shipment and destination of shipment.

For example, if distance between the origin of shipment and destination of the shipment is greater than a threshold, the shipping service provider may have additional cost. Further, some locations may have difficult pickup or delivery, access restrictions, limited mode of access, tolls (e.g., by ferry), etc. and hence may have higher shipping cost. Further, shipping charges may also be dependent upon characteristics of the individual package, e.g., dimensions (length, width, height), circumference in one or more dimensions, weight, type of packaging, type of contents (e.g., printed material, hazardous material), special handling requirements (e.g., fragile), insurance, speed of delivery (e.g., overnight or bulk mail), and so forth. Further, the package-related expenses may vary with the pick-up and/or delivery locations. The shipping cost rules may further include idiosyncrasies of the shipping service provider. The shipping service provider may provide exception for operation in given areas or addresses. For example, a particular shipping service provider may charge extra for delivery of shipments in a particular area or may not deliver in a particular area.

Further, the profile module 202 may enable the shipping service provider to associate a plurality of shipping cost rules with a plurality of shipping services provided by the shipping service provider. For example, a particular shipping service provider may have a ground service, an express service, and an express US service. The shipping service provider may associate different shipping cost rules with the different services. For example, ground rating shipping cost rules may be associated with ground service, express rating shipping cost rules may be associated with express service, and express US rating shipping cost rules may be associated with express US service. Further, the profile module 202 may enable the shipping service provider to select a rating type (e.g., flat rating, package level rating or dimensional rating) for a rating method (i.e., ground service, an express service, and an express US service).

The flat rating type may provide a flat rate cost for a shipment based on a cost table for this rating method. The package level rating may evenly split the total shipping charge among the packages in the shipment. The dimensional rating may utilize the following formula to calculate dimensional weight, dimensional weight=(Length×Width×Height)/Dim Factor. The profile module 202 may further enable the shipping service provider to edit the rating method or rating type associated with a particular shipping service. The shipping service provider may add rates with each of the rating method. In an embodiment, the shipping service provider may add an individual rate by entering the values manually. In another embodiment, the shipping service provider may import a rates file containing a complete list of rates.

According to an embodiment of the present invention, the profile module 202 may associate various parameters against the shipping cost rules. For example, origin of shipment may be associated with an origin parameter, and destination of the shipment may be associated with a destination parameter. Further, various types of packages may be categorized, for example, electronics, clothing, footwear, books, toys, etc., and a package type parameter may be associated with the type of packages. The shipping service provider may provide his shipping cost (including details, for example, base charge, service charge etc.) for each combination of the origin parameter, destination parameter, and the package type parameter.

Further, if the shipping charge provider provides some idiosyncrasies, then the profile module 202 associates the idiosyncrasies against the applicable parameter. For example, if a particular shipping service provider does not pick the shipment from a particular place, but is ready to deliver the shipment to the particular place, then the profile module 202 may associate such unique combination with ‘service not available at the given location’. Further, if the shipping service provider charges more from pick-up and delivery to a particular place, then these idiosyncrasies may be associated with that combination of the pick-up and delivery places.

The shipping cost rules may be stored in the enterprise database 160 by the profile module 202. Similarly, plurality of shipping service provider may register on the shipper selection system 102, and make their profiles for their shipping services geographic range and shipping services cost rules.

In an embodiment, the profile module 202 may also provide login options. In an embodiment, login options for a user (who wants to place the shipping order or want to do shipping cost comparison for strategic reasons, for example, a large volume shipper) and a shipping service provider may be different.

The update module 204 is configured to enable the shipping service provider to update his shipping services geographic range or add exceptions to the shipping services operations. For example, the shipping service provider may decide to expand to some geographic area for his services, or he may decide to drop some geographic area from his services range, or he may decide to change his shipping cost for particular areas. The shipping service provider may utilize the update module 204 to update or change his shipping services cost or geographic operations details. The update module 204 may associate change desired by the shipping service provider with a relevant parameters combination and the change may be stored in the enterprise database 160. The shipping service provider may add exceptions to some of the locations for his services, or he may provide some further idiosyncrasies regarding particular service charges to be added for particular packages or particular locations. The idiosyncrasies may be associated with a relevant parameters combination, and stored in the enterprise database 160. In the future, if the unique parameters combination services is desired by a user, corresponding cost may be displayed to the user.

The parameter determining module 206 is configured to determine parameters related to a package to be shipped. The parameters may be provided by a user, who is enquiring about the shipment cost for a particular package or a particular type of service (e.g., carrier “A” for overnight, carrier “B” for two-day). The user may want to compare the shipping cost for the particular package, or may be looking to explore options for shipping the packages. In an embodiment of the present invention, the parameters include a shipment origin, a shipment destination, and details of the package that is required to be shipped. The details of the package may include weight and dimension of the package. Further, in an embodiment, the details of the package may include time to deliver the package from the origin to the destination. In another embodiment of the present invention, the parameters may include any characteristics related to the package that may have an effect upon the shipping cost.

The retrieval module 208 is configured to retrieve shipping cost rules of one or more shipping service providers. In an embodiment, the retrieval module 208 may retrieve the shipping cost rules from the enterprise database 160. In an embodiment of the present invention, each of the shipping service providers may have different shipping cost rules. For example, the one or more shipping service provider may have different base rate, different surcharge rate, or different service charge rate for shipping. The shipping cost rules are predefined by the one or more shipping service providers. Further, one shipping service provider may charge additional charge or cost if distance between the origin and destination is greater than a threshold, while another shipping service provider may not have any separate cost based on distance, but only based upon the package type. Further, one shipping service provider may have separate scheme like express delivery for shipping the shipment same day and normal delivery. While, another shipping service provider may have single scheme like express delivery or normal delivery. Further, one shipping service provider may have more resources in a given geographic area and may charge less for delivering within that geographic area, while another shipping service provider may have uniform resources across all of the geographic areas. Further, some shipping service provider may have some idiosyncrasies for a particular combination of parameters that can have affect on the shipping cost.

The contract module 210 is configured to retrieve contracts of the one or more shipping service providers. In an embodiment, the contract module 210 may retrieve the contracts rules for the one or more shipping service providers from a contract database 168. In an embodiment of the present invention, contract rules may include special discount offered by a particular shipping service provider to ship some specific packages to specific destination. Further, a particular shipping service provider may provide discount for a particular type of package for a particular destination. Furthermore, a particular shipping service provider may provide discount if number of packages required to be shipped are greater than a threshold and these packages are to be shipped to a particular destination. For example, a shipping service provider may offer twenty percent discount if the shipper is shipping forty-pound boxes to Utah.

The calculating module 212 is configured to calculate one or more shipping cost for the corresponding one or more shipping service providers. In an embodiment, the calculating module 212 calculates the one or more shipping costs based upon the determined parameters, retrieved shipping cost rules, and retrieved contract rules. As discussed above, each of the shipping service providers may have different shipping cost rules for their shipping charges. Further, some of the shipping service providers may have idiosyncrasies related to a unique combination of parameters. The calculating module 212 is configured to utilize the idiosyncrasies of the shipping service provider, and calculate the shipping charge for the package to be shipped. The calculating module 212 may prepare combination of the parameters determined, and search in the shipping cost rules for a combination of parameters in order to calculate the shipping cost. Further, some of the shipping service provider may have specific contract, which may be revealed during the retrieval of the contracts rule. The calculating module 212 is configured to utilize the retrieved contracts rules, and calculate shipping cost for each of the shipping service provider separately.

According to an embodiment of the present invention, the shipping cost rules related to one or more shipping service providers, and contracts rules related to some or all of the shipping service providers are stored separately (or bifurcated) in the enterprise database 160 and contracts database 168, respectively. Further, retrieval and processing of the shipping cost rules and the contract rules is performed separately by separate modules (i.e., retrieval module 208 for shipping cost rules and contracts module 210 for contract rules).

The calculating module 212 is further configured to display the one or more shipping cost to the user. The one or more shipping service cost corresponds to one or more shipping service providers. In an embodiment of the present invention, the calculating module 212 may display the shipping service options for the user in order of increasing shipping cost, wherein minimum cost is displayed at first. In another embodiment of the present invention, the calculating module 212 may display the shipping service options for the user in order of decreasing shipping cost, wherein maximum shipping cost is displayed at first. In another embodiment of the present invention, the calculating module 212 may display those shipping service provider options in start, which have been used by the same user in past. In another embodiment of the present invention, the calculating module 212 may display the shipping service options in alphabetical order. In another embodiment of the present invention, the calculating module 212 may display the shipping service options in order of their general popularity. In another embodiment of the present invention, the calculating module 212 may display the shipping service options in order of expertise of the shipping service providers for the given type of package (e.g., electronics, clothing etc.), or for given origin, or for given destination. Further, in an embodiment of the present invention, the calculating module 212 may enable the user to change the display or sorting of shipping options based on any of above options. Furthermore, the calculating module 212 may enable the user to provide suggestion or feedback for the default display of options in the future for the user or addition of any more option in the display options to better meet the user's requirements.

The calculating module 212 may further display details of the shipping cost for each of the shipping service provider. For example, the total shipping cost for a particular shipping service provider may include base charge, service charge, oversize charge, insurance charge, cash on delivery (COD) charge, residential area charge, delivery area surcharge, remote area surcharge, Saturday delivery charge among others. The users may then compare the shipping cost for the multiple shipping service providers based on this break-up of the cost. In an embodiment of the present invention, calculating module 212 may also provide the comparison between two shipping service providers or among many shipping service providers if the user selects a list of the shipping service providers to have a comparison.

The selection module 214 is configured to enable the user to select a shipping service provider among the plurality of shipping service providers. In an embodiment of the present invention, user may select a shipping cost provider offering minimum cost for shipping the package. In another embodiment of the present invention, the user may select a different shipping service provider based on other factors such as reputation of the shipping services provider, past experiences with the shipping service provider, affinity-based reasons (e.g., a frequent shipper club; discounts based on the identity of the ultimate end user, e.g., a special rate for Amazon® or for real estate agents), etc. In another embodiment, these other factors may already be included in the idiosyncrasies of the shipping cost rules.

FIG. 3 is a flowchart of a method 300 for enabling a shipping service provider to register his profile on the shipper selection system. At step 302, a shipping service provider is enabled to register and create a profile on the shipper selection system. In an embodiment of the present invention, the shipping service provider may be enabled to register by the profile module 202.

At step 304, the shipping service provider is enabled to provide details of geographic ranges of his shipping services. In an embodiment, the shipping service provider may be provided various geographic codes for various geographic origin, which may be selected by the shipping service provider to indicate his geographic range of operations for picking up (i.e., origin of package) and delivering the shipments (i.e., destination of the package). The shipper details may further include expertise of the shipping service provider related to specific type of packages or specific places for speedy operation. The details of the geographic range of shipping service provided by the shipping service provider may be saved in the enterprise database 160. In an embodiment of the present invention, details of the geographic ranges may be provided by the profile module 202.

At step 306, the shipping service provider is enabled to provide details of shipping cost for his shipping services. In an embodiment, the shipping cost details of a shipping service provider may be different from another shipping service provider because of different resources, operations, and expertise. Further, the shipping services provided by the shipping service providers may be different in terms of time for example, a normal service or express service. The details of the shipping cost rules provided by the shipping service provider may be saved in the enterprise database 160. In an embodiment of the present invention, the shipping cost details may be provided by the profile module 202.

At step 308, it is determined whether a change request has been requested by the shipping service provider. If the change request has not been requested, the method 300 ends. Otherwise, the method 300 proceeds towards step 310.

At step 310, the shipping service provider is enabled to update the desired change related to range of geographic area for his shipping services, or shipping cost rules, or some idiosyncrasies. For example, a shipping service provider may decide to expand geographic area for his shipping services, or he may decide to drop some geographic area from his services range, or he may decide to change his shipping cost for particular areas. In an embodiment of the present invention, desired changes may be performed by the update module 204.

FIG. 4 is a flowchart of a method 400 for selecting a shipping service provider from a plurality of shipping service providers based upon specific factors of the shipment. At step 402, parameters for a package to be shipped are determined. In an embodiment of the present invention, parameters of the package comprise an origin, a destination of the package, a weight, and dimension of the package. Further, the parameters of the package may include time to deliver the package from the origin to the destination. In an embodiment of the present invention, the parameters of the package may be determined by the parameters determining module 206.

At step 404, shipping cost rules for each of the shipping service provider are retrieved from an enterprise database. The shipping cost rules may comprise general shipping cost rules for one or more shipping service providers. The shipping cost rules may describe different shipping rules employed by different shipping service providers for calculating shipping cost for various types of packages from various origins to various destinations. The shipping cost rules are predefined by the one or more shipping service providers. In an embodiment, the shipping cost rules are retrieved from an enterprise database 160. In an embodiment of the present invention, the shipping cost rules may be retrieved by the retrieval module 208.

At step 406, it is determined whether contracts are available for one or more shipping service providers. If there are one more contracts available, then the method 400 proceeds to step 408. Otherwise, the method 400 proceeds to step 410.

At step 408, contracts for the one or more shipping service providers are retrieved. Contracts may describe specific agreements between a shipper and a shipping service provider any special discounts or schemes. In an embodiment, contract rules may include agreement related to discount offered by the one or more shipping service providers for a particular type of package for a particular destination. Further, the contract rules may include agreement related to discount offered by the one or more shipping service providers for a number of packages greater than a threshold to be shipped to a particular destination. For example, a shipping service provider may offer twenty percent discount if the shipper is shipping forty-pound boxes to Utah. In an embodiment, the contracts may be retrieved from the contracts database 168. According to an embodiment of the present invention, the shipping cost rules and contracts rules are separately stored and processed for the one or more shipping service providers. In an embodiment of the present invention, the contracts may be retrieved by the contracts module 210.

At step 410, shipping cost is calculated for the one or more shipping service providers. In an embodiment, the calculated shipping costs are based upon the determined parameters, retrieved shipping cost rules, and retrieved contract rules. In an embodiment of the present invention, the shipping cost may be calculated by the calculating module 212.

At step 412, s shipping service provider from the one or more shipping service providers is selected based upon the calculated shipping cost. In an embodiment, a shipping service provider offering minimum shipping cost for shipping the package is selected. In another embodiment, the shipping service provider may be selected based upon popularity, brand, rating, affinity, past experiences, etc. In an embodiment of the present invention, the shipping service provider parameters may be selected by the selection module 214.

The exemplary systems and methods of this present invention have been described in relation to a particular enterprise network. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example, in one alternative embodiment, the systems and methods of this present invention can be implemented in conjunction with a special purpose computer, programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A shipper selection system, comprising:
a parameter determining module configured to determine parameters of a package to be shipped;
a retrieval module configured to retrieve shipping cost rules for one or more shipping service providers;
a contract module configured to retrieve contract rules for the one or more shipping service providers;
a calculating module configured to calculate one or more shipping costs based upon the determined parameters, retrieved shipping cost rules, and retrieved contract rules; and
a selection module configured to select a shipping service provider based upon the calculated one or more shipping costs.

2. The shipper selection system of claim 1, wherein the parameters of the package comprise an origin and a destination of the package.

3. The shipper selection system of claim 2, wherein the parameters of the package further comprises weight and dimension of the package.

4. The shipper selection system of claim 2, wherein the parameters of the package further comprises time to deliver the package from the origin to the destination.

5. The shipper selection system of claim 1, wherein the retrieval module retrieves the shipping cost rules from an enterprise database.

6. The shipper selection system of claim 1, wherein the contract module retrieves the contract rules for the one or more shipping service providers from a contracts database.

7. The shipper selection system of claim 1, wherein the shipping cost rules are predefined by the one or more shipping service providers.

8. The shipper selection system of claim 1, wherein the contract rules comprises agreement related to discount offered by the one or more shipping service providers for a particular type of packages for a particular destination.

9. The shipper selection system of claim 1, wherein the contract rules comprises agreement related to discount offered by the one or more shipping service providers for a number of packages greater than a threshold to be shipped to a particular destination.

10. The shipper selection system of claim 1, wherein the selection module selects a shipping service provider offering minimum shipping cost for shipping the package.

11. The shipper selection system of claim 1, wherein the selection module selects a shipping service provider based upon the calculated one or more shipping costs, and a rating of the one or more shipping service providers.

12. The shipper selection system of claim 1, further comprising a profile module configured to enable the one or more shipping service provider to register a geographic range and shipping cost rules for his shipping services.

13. The shipper selection system of claim 12, further comprising an update module configured to enable the one or more shipping service provider to update a geographic range or shipping cost rules for his shipping services.

14. The shipper selection system of claim 13, wherein the update module is configured to enable the one or more shipping service provider to update idiosyncrasies related to his shipping services.

15. A computer-implemented method to select a shipping service provider, comprising:
determining parameters of a package to be shipped;
retrieving shipping cost rules from for one or more shipping service providers;
retrieving contract rules for the one or more shipping service providers;
calculating one or more shipping costs based upon the determined parameters, retrieved shipping cost rules, and retrieved contract rules; and
selecting a shipping service provider based upon the calculated one or more shipping costs.

16. The computer-implemented method of claim 15, wherein the parameters of the package comprises an origin, a destination, weight, and dimension of the package.

17. The computer-implemented method of claim 16, wherein the parameters of the package further comprises time to ship the package from the origin to the destination.

18. The computer-implemented method of claim 15, wherein the contract rules comprises agreement related to discount offered by the one or more shipping service providers for a particular type of package for a particular destination,

19. The computer-implemented method of claim 15, wherein the selecting comprises selecting a shipping service provider offering minimum shipping cost for shipping the package.

20. The computer-implemented method of claim 15, further comprising enabling the one or more shipping service provider to update a geographic range or shipping cost rules for his shipping services.

21. A computer-implemented method, comprising
separating into portable content the expression of a carrier's rules rates, and discounts; and
executing this content.

22. The method of claim 21, wherein the content is separated so customer-specific contractual information (e.g., rules, rates, discounts) is not stored in the carrier content bundle so the carrier content is portable across different customers.
